(19) United States
(12) Patent Application Publication
(10) Pub. No.: US 2020/0390086 A1
(43) Pub. Date: Dec. 17, 2020

(54) Decoy Holder System

(71) Applicant: Scott A. Butz, Fargo, ND (US)

(72) Inventor: Scott A. Butz, Fargo, ND (US)

(21) Appl. No.: 16/696,075

(22) Filed: Nov. 26, 2019

Related U.S. Application Data
(60) Provisional application No. 62/860,899, filed on Jun. 13, 2019.

(51) Int. Cl. A01M 31/06

(52) U.S. Cl. CPC A01M 31/06

(57) ABSTRACT

A decoy holder system for facilitating the transport of large numbers of decoys. The decoy holder system generally includes a channel in the decoy body and a flexible loop member having two ends secured within a crimp which may be securely lodged within the channel in the decoy body. The channel may have two non-coaxial portions, such as a horizontal hole extending into the tail portion of the decoy, which intersects with a vertical hole that extends upwardly from the bottom, rear portion of the decoy. The external portion of the flexible loop member forms a carrying loop external to the decoy body that extends beyond the decoy body.

### CROSS REFERENCE TO RELATED APPLICATIONS

I hereby claim benefit under Title 35, United States Code, Section 119(e) of U.S. provisional patent application Ser. No. 62/860,899 filed Jun. 13, 2019 (REEL-025). The 62/860,899 application is currently pending. The 62/860,899 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a decoy holder system that allows for greater ease in carrying large numbers of decoys.

### Related Art

Any discussion of the related art throughout the specification should in no way be considered as an admission that such related art is widely known or forms part of common general knowledge in the field.

Waterfowl and other large-bird decoys have been in use for many years to help hunters attract birds such as turkeys, geese and ducks to a favorable hunting location. Full-body decoys are available in a number of types, with varying degrees of realism and motion. Such decoys have a common trait, however, which is that they are large, bulky, and hard to carry in large numbers.

Past designs for decoys have typically been made without regard for carrying and transporting the decoys in large numbers, even though some decoy spreads may use dozens of decoys.

### SUMMARY

An example embodiment is directed to a decoy holder system. The decoy holder system is usable for a decoy having a decoy body, and includes a channel in the decoy body comprising a first opening and a second opening, and a flexible loop member having two ends secured within a crimp or by other means, such as a nylon ty-wrap, the loop member comprising an external portion and a portion positioned within the channel in the decoy body. The channel may comprise two non-coaxial portions, such as a horizontal hole extending into the tail portion of the decoy, which intersects with a vertical hole that extends upwardly from the bottom, rear portion of the decoy.

The external portion of the flexible loop member forms a carrying loop external to the decoy body that extends outwardly between the first opening and the second opening.

In some embodiments of the holding system, the crimp may be a metal crimp. In addition, the metal crimp may be securely positioned within the channel in the decoy body. The metal crimp can comprise a first crimp channel and a second crimp channel, wherein a first end of the flexible loop member is secured in the first crimp channel and the second end of the flexible loop member is secured in the second crimp channel.

If a metal crimp is used, it may be securely positioned within the channel in the decoy body, such as in the vertical hole that extends upward into the decoy. The metal crimp may be sized so that it can be tilted and forced into the channel, creating a retaining force that holds the crimp and the flexible loop member securely within the rear portion (or any other desired part) of the decoy.

In some example embodiments, the flexible loop member may be a bungee cord, although other embodiments, such as a cable or nylon cord, are also possible.

Still further embodiments provide for a method for adding a holding system to a decoy having a decoy body and a channel in the decoy body comprising a first opening and a second opening. The method may include the steps of inserting the first end of a flexible loop member into the channel until the first end extends beyond the decoy body, and then inserting the first end of the flexible loop member into a crimp. With the flexible loop member thus threaded into the decoy body, the second end of the flexible loop member can be inserted into the crimp.

The method also may include deforming the crimp to secure the first end and the second end of the flexible loop member within the crimp, which may then be inserted into the channel in the decoy body. After such assembly, a portion of the flexible loop member remains within the channel, and an external portion of the flexible member forms a carrying loop external to the decoy body that extends outwardly between the first opening and the second opening.

The method may also include forming the channel in the decoy body—for example, by drilling one or more holes through the body. In one example embodiment, two holes may be drilled, as discussed above, which may be non-coaxial. Specifically, one hole may be horizontal and another vertical, and the holes may intersect within the decoy body to form a channel.

There has thus been outlined, rather broadly, some of the embodiments of the decoy holder system in order that the detailed description thereof may be better understood, and in order that the present contribution to the art may be better appreciated. There are additional embodiments of the decoy holder system that will be described hereinafter and that will form the subject matter of the claims appended hereto. In this respect, before explaining at least one embodiment of the decoy holder system in detail, it is to be understood that the decoy holder system is not limited in its application to the details of construction or to the arrangements of the components set forth in the following description or illustrated in the drawings. The decoy holder system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a number of decoys in accordance with an example embodiment deployed in an outdoor environment.

FIG. 2 is a lower perspective view showing a decoy on a stake in accordance with an example embodiment.

FIG. 3 is a rear perspective view showing a number of decoys with the holder system in use in accordance with an example embodiment.

FIG. 4 is a bottom perspective view of a decoy being prepared in accordance with an example embodiment.

FIG. 5 is another bottom perspective view of a decoy being prepared in accordance with an example embodiment.

FIG. 6 is a bottom perspective view of a decoy ready for installation of a holder system to be installed in accordance with an example embodiment.

FIG. 7 is a sectional view of a decoy taken at line 7-7 as shown in FIG. 6, in accordance with an example embodiment.

FIG. 8 is a perspective view of components of a decoy holder system usable in accordance with an example embodiment.

FIG. 9 is a bottom perspective view of a decoy holder system being assembled in accordance with an example embodiment.

FIG. 10 is another bottom perspective view of a decoy holder system being further assembled in accordance with an example embodiment.

FIG. 11 is another bottom perspective view of a decoy holder system being further assembled in accordance with an example embodiment.

FIG. 12 is another bottom perspective view of a decoy holder system being further assembled in accordance with an example embodiment.

FIG. 13 is another bottom perspective view of a decoy holder system being further assembled in accordance with an example embodiment.

FIG. 14 is a bottom perspective view of a decoy holder system in accordance with an example embodiment.

### DETAILED DESCRIPTION

### A. Overview.

An example decoy holder system generally comprises a moving decoy 10, such as a full-body decoy having a decoy body 20. The decoy holder system is usable for a decoy having a decoy body 20, and includes a channel 25 in the decoy body 25 comprising a first opening 24 and a second opening 22, and a flexible loop member 12 having two ends secured within a crimp 14 or by other means, such as a nylon ty-wrap, the loop member 12 comprising an external portion and a portion positioned within the channel 25 in the decoy body 20. The channel may comprise two non-coaxial portions 25a and 25b, such as a horizontal hole 25b extending into the tail portion of the decoy, which intersects with a vertical hole 25a that extends upwardly from the bottom, rear portion of the decoy 10.

The external portion of the flexible loop member 12 forms a carrying loop 13 external to the decoy body 20 that extends outwardly between the first opening 24 and the second opening 22 in the decoy body 20. The crimp 14 may be a metal crimp. For example, it may be made of aluminum or any other metal capable of being easily crimped or deformed in order to securely hold a flexible member sized properly to fit within the crimp's openings. In addition, the metal crimp 14 may be securely positioned or lodged within a channel 25 in the decoy body 20. The metal crimp 14 can comprise a first crimp channel 15 and a second crimp channel 16, wherein a first end 12a of the flexible loop member 12 is secured in the first crimp channel 15 and the second end 12b of the flexible loop member 12 is secured in the second crimp channel 16.

If a metal crimp is used, it may be securely positioned within the channel 25 in the decoy body, which may comprise a vertical portion 25a and a horizontal portion 25b. The crimp or joined flexible loop member 12 may be lodged securely in the vertical hole or channel portion 25a that extends upward into the decoy 10. The metal crimp 14 may be sized in length so that it can be tilted and securely lodged into the channel portion 25a, creating a retaining force that holds the crimp 14 and the flexible loop member 12 securely within the rear portion (or any other desired part) of the decoy 10.

In some example embodiments, the flexible loop member 12 may be a bungee cord, although other embodiments, such as a cable or nylon cord, are also possible.

Still further embodiments provide for a method for making or adding a holding system to a decoy having a decoy body 20 and a channel 25 in the decoy body comprising a first opening 24 and a second opening 22. The method may include the steps of inserting the first end 12a of a flexible loop member 12 into the channel 25 until the first end 12a extends beyond the decoy body 20, and then inserting the first end 12a of the flexible loop member into a crimp 14, and more specifically, into a first channel 15 of the crimp. With the flexible loop member 12 thus threaded into the decoy body, the second end 12b of the flexible loop member can be inserted into the crimp 14, such as a second channel 16 of the crimp.

The method also may include compressing or deforming the crimp 14 to secure the first end 12a and the second end 12b of the flexible loop member 12 within the crimp, which may then be inserted into the channel 25 in the decoy body, for example, in the vertical portion 25a of the channel. After such assembly, an external portion of the flexible member 12 forms a carrying loop 13 external to the decoy body 20 that extends outwardly between the first opening 24 and the second opening 22 of the decoy.

The method may also include forming the channel 25 in the decoy body—for example, by drilling one or more holes into the body 20. In one example embodiment, two holes may be drilled, as discussed above, which may be non-coaxial. Specifically, one hole or channel portion 25b may be horizontal and another hole or channel portion, 25a, may be vertical, and the holes may intersect within the decoy body 20 to form a channel 25.

The decoy holder system is usable with decoys that are mounted on stakes 30 to hold them above the ground, wherein the decoys are held by motion cones 28 into which stakes 30 are inserted. The stake and motion cone mounting system allows the decoys to move when there is wind or a breeze, making the decoys move in a more natural way. As mentioned above, a decoy spread may consist of a very large number of decoys, which are sometimes carried to the stakes, which may be pre-positioned in a desired location.

### B. Channel.

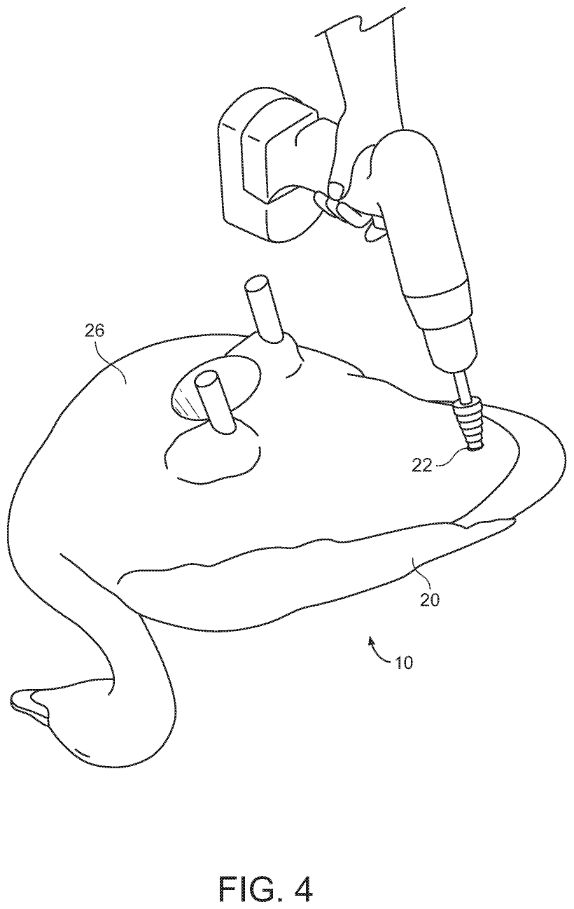

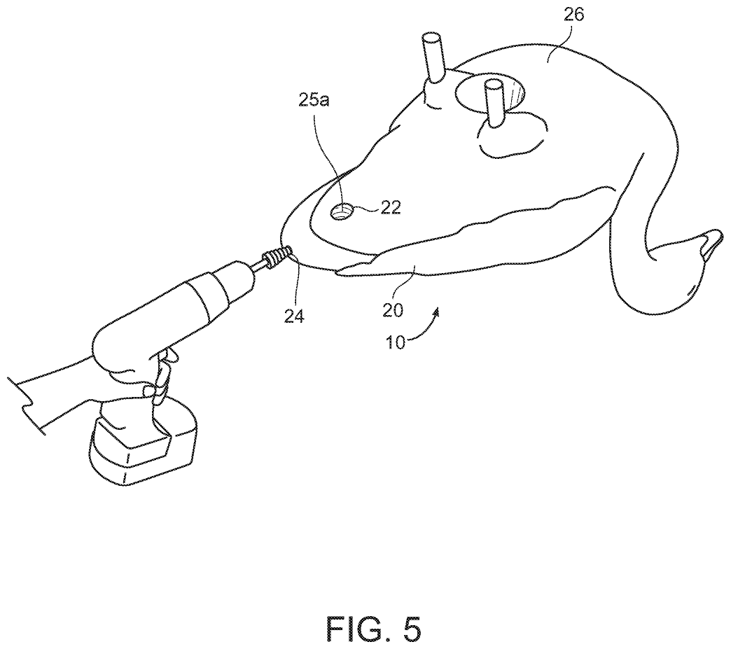

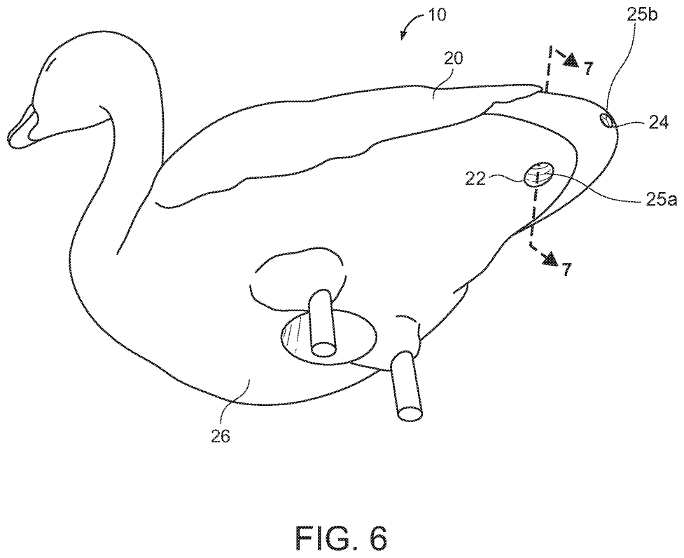

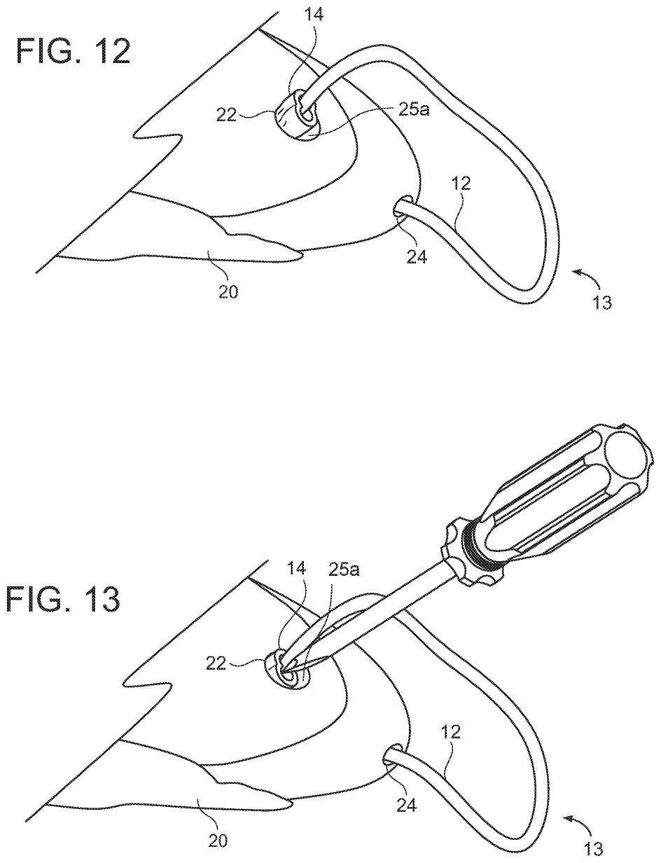

As best shown in FIGS. 6 and 7, a decoy with a holder installed may have a channel 25, comprising a portion 25a and portion 25b. This channel may be formed by drilling or otherwise forming two intersecting holes, such as non-coaxial holes, in the decoy body, as shown in FIGS. 4 and 5, typically in the rear and underside of the body 20, although other locations are possible as well. For reasons explained below, a larger hole, to form channel portion 25a, may be drilled in the bottom surface 26 of the decoy body 20. In addition to non-coaxial holes, it would also be possible to drill a single hole through the decoy body, or a portion of it, and enlarge a portion of the hole to retain and hold a crimp or other connection joining the ends of flexible loop member 12. As also shown in FIG. 7, the channel portion 25a may be larger in diameter than portion 25b, to allow more room for the crimp 14 to be installed and lodged into the channel, as shown in FIGS. 12-14.

The channel also has openings 22 and 24, through which the flexible loop member 12 can be threaded and retained. As shown in FIGS. 4 and 5, the channel may be formed by drilling with a hand drill, although it would also be possible to form the channel 25 by molding it into the decoy body 20, or by a more automated process, such as drilling in a drill press while the decoy is held manually or in a fixture. In addition to being installed at the time of manufacture, the decoy holder system may also be installed on existing decoys, using the same components and configurations shown here. For example, a hunter or supplier, etc., could drill the holes as shown to create channel 25, and then install the flexible loop member 12 to create carrying loop 13.

### C. Carrying Loop.

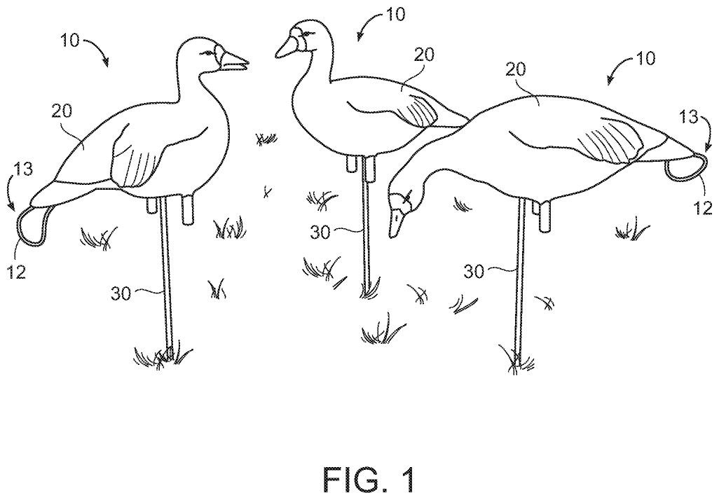

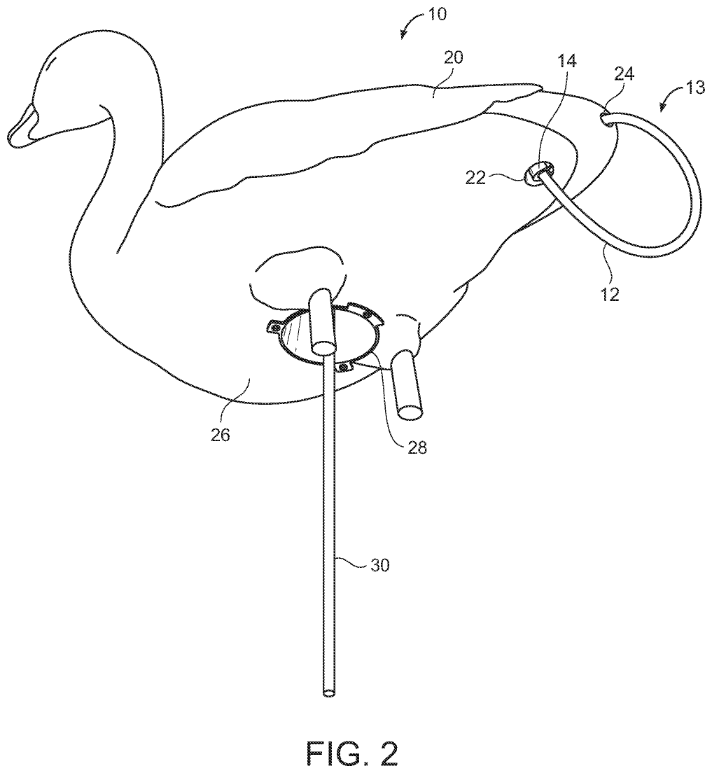

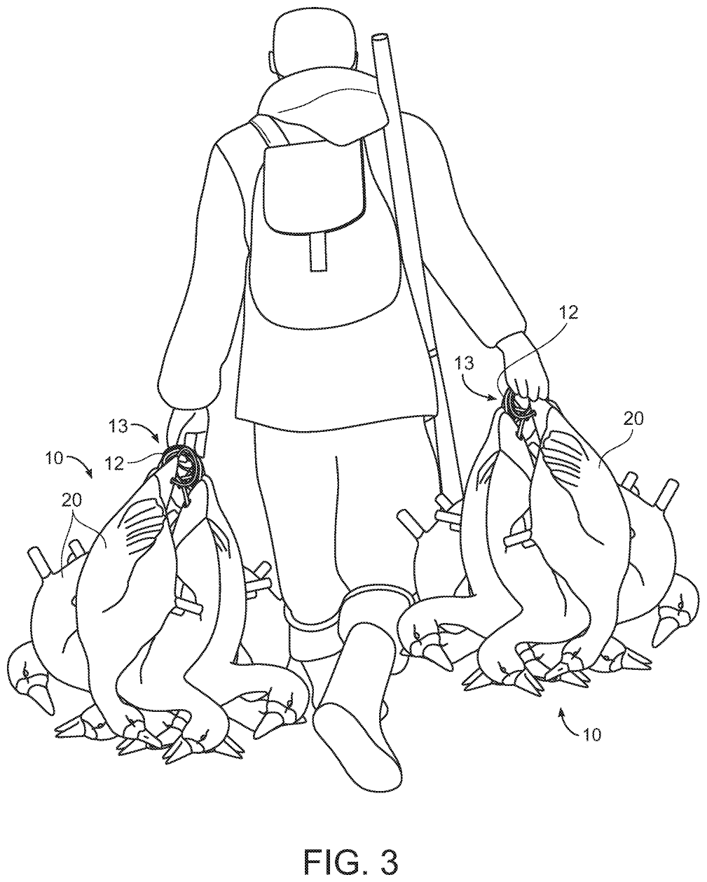

As best shown in FIG. 3, and also throughout the figures, the decoy holder system comprises a flexible carrying loop 13 at the tail location of each decoy, which allows for large numbers of decoys 10 to be carried to a hunting area, as shown. As also shown, for example in FIGS. 1 and 2, the carrying loops 13 do not detract from the realistic look of the decoys, allowing them to be used as any other decoy would be used, such as a full body, moving decoy.

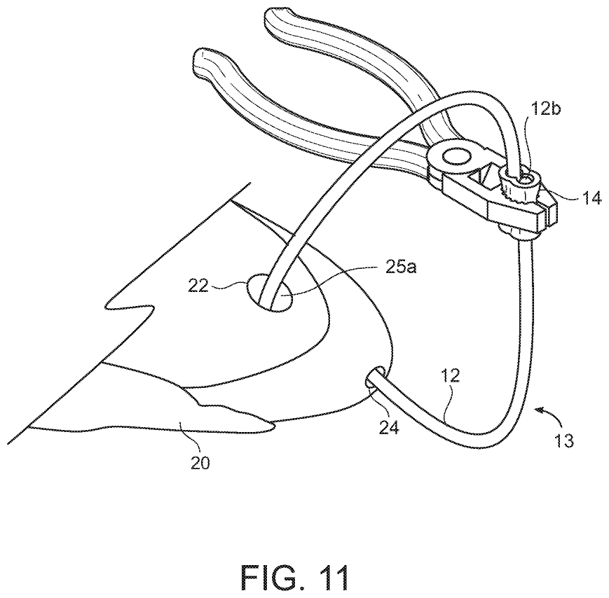

The carrying loop 13 is threaded through the body 20 of the decoy 10, as generally shown in FIGS. 1-3 and 9-14. The carrying loop 13 is formed once flexible loop member 12 is installed in the decoy body 20 and crimped or otherwise joined to form a loop. The carrying loop 13 may have a crimp 14 that is firmly lodged within channel 25, or more specifically, channel portion 25a, as shown in FIGS. 12-13. In such a configuration, the loop member will not slip or move freely within channel 25. This ensures that the crimp does not “travel” when decoys are being carried, and also allows for a consistent feel to the person carrying the decoys. However, it is also possible to form a carrying loop 13 without securing the crimp or ends 12a and 12b within the decoy body 20, which would allow the flexible member 12 of the carrying loop 13 to slide within channel 25.

### D. Operation of Preferred Embodiment.

In use, a number of decoys 10 may be placed in a desirable hunting location in a decoy spread to simulate a natural gathering of waterfowl or other game birds, as shown in FIG. 1. In addition, it is often desirable for at least some of the decoys to exhibit natural motion, similar to actual birds, in order to attract game birds, which can be cautious, especially if decoys do not appear to be real birds to at least some extent, or to be simulating a behavior that gives the target fowl confidence in the area, or creates curiosity. As shown in FIG. 2, numerous decoys 10 supported by stakes 30 can rotate in the presence of wind, and can also rock or wobble, which can create the appearance of natural feeding motion of the decoys. This occurs due to a motion cone 28 that allows the decoy body 20 to move in several directions when supported by stake 30.

Typically, a hunter may set up a decoy spread by first placing multiple stakes 30 in the ground in a pattern, for placement of multiple decoys 10 in the area. Further, the stakes 30 may be placed some time ahead of when the decoys will be used, or may be left in place for some time. Accordingly, a hunter may need to carry a large number of decoys 10 for placement on stakes 30 prior to hunting, as shown in FIG. 3. The decoy holder system allows for many more bulky, awkward decoys to be carried to a hunting area than would otherwise be possible. For example, using the system, twenty or more decoys may be carried by a single hunter.

To make a decoy with the decoy holder system, as best shown in FIGS. 4 and 5, a channel 25, comprising a portion 25a and portion 25b, may be drilled or formed in the decoy body 20. These may be two intersecting holes, such as non-coaxial holes, in the decoy body, typically in the rear and underside portion of the body 20, although other locations are also possible. Once a channel is made, it may have the shape and configuration shown in FIG. 7, which specifically shows two holes or channel portions 25a and 25b at right angles to each other, with channel portion 25a having a larger diameter than channel portion 25b.

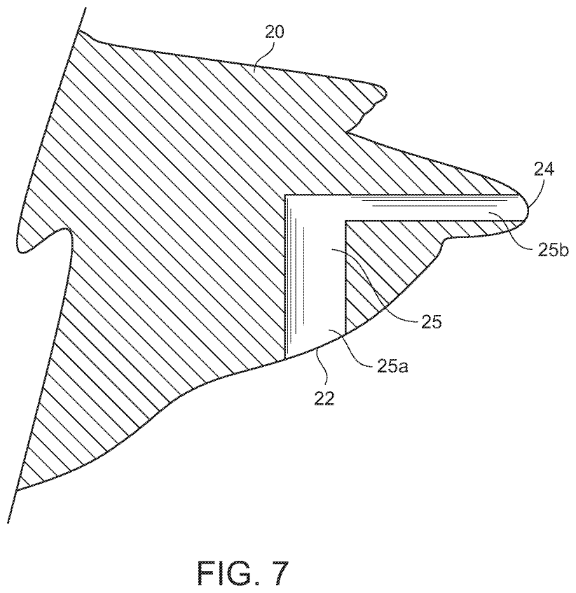

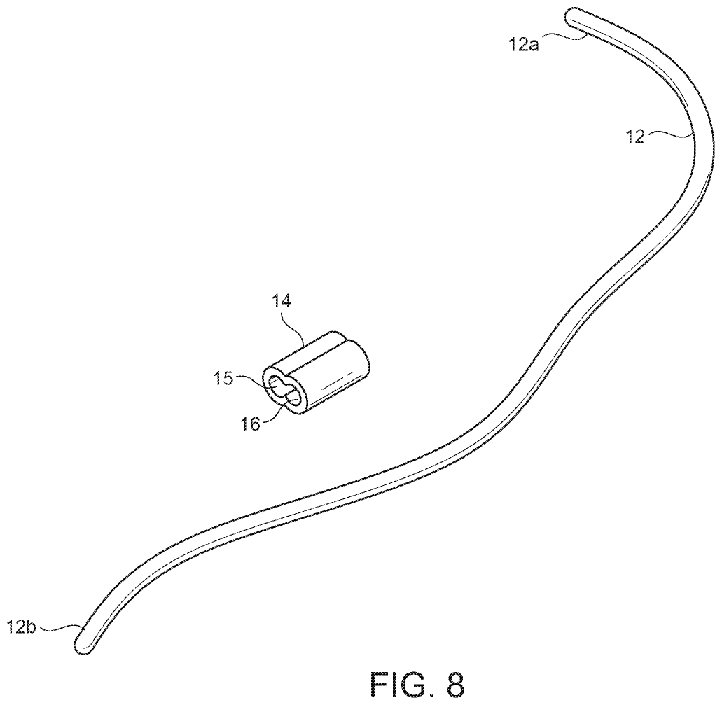

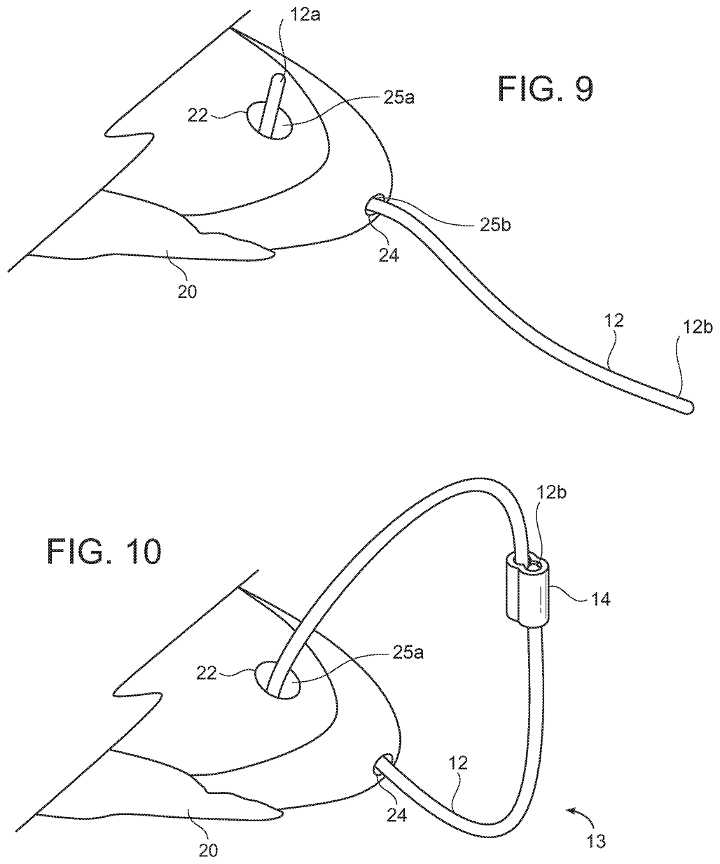

To continue the process, as shown in FIGS. 9-11, an end 12a of flexible loop member 12, which may be a cord, coated cable or wire, plastic element, bungee cord, etc., is threaded into opening 24 and into channel portion 25b, so that it will enter channel portion 25a and extend out of opening 22. Next, end 12a can be inserted into a channel 15 of crimp 14, as shown in FIGS. 8 and 10, and end 12b of the flexible loop member 12 can be inserted into channel 16 of crimp 14, as also shown. The crimp 14 can then be compressed or deformed with pliers or a specialized crimping tool to hold flexible loop member 12 securely within crimp 14. As mentioned above however, other components and methods of securing or joining the ends 12a and 12b of flexible loop member 12 may also be used, such as nylon ty-wraps, wire wraps, etc.

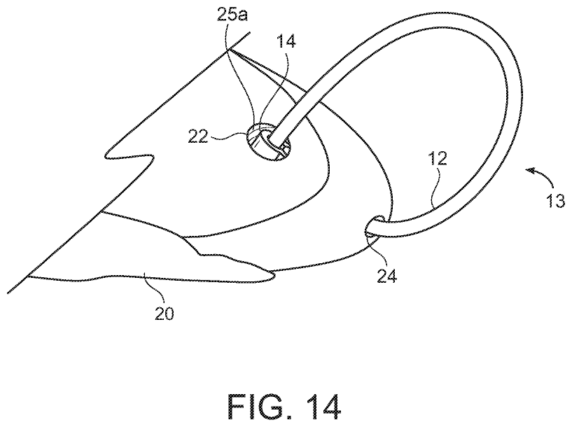

As shown in FIG. 12, if a crimp, such as a metal crimp, is used, the crimp may be sized so that when it is positioned at an angle within channel portion 25a, it must be forced into the channel, creating a retention force. Thus, after a crimp 14 it is inserted into 25a, a manufacturer or user may lodge it securely into the channel, such as by angling it into the channel and forcing the crimp into the channel 25a with a screwdriver or other tool, as shown in FIG. 13. The physical properties of the decoy body 20 can serve to hold the crimp 14 and accordingly, loop member 12, securely in place, as shown in FIG. 14.

Unless otherwise defined, all technical and scientific terms used herein have the same meaning as commonly understood by one of ordinary skill in the art to which this invention belongs. Although methods and materials similar to or equivalent to those described herein can be used in the practice or testing of the decoy holder system, suitable methods and materials are described above. All publications, patent applications, patents, and other references mentioned herein are incorporated by reference in their entirety to the extent allowed by applicable law and regulations. The decoy holder system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A holding system for a decoy having a decoy body, comprising:
a channel in the decoy body comprising a first opening and a second opening in the decoy body; and
a metal crimp comprising a first crimp channel and a second crimp channel;
a flexible loop member having a first end and a second end fixedly secured by the metal crimp, each end of the flexible loop member being positioned at opposite ends of the metal crimp, the first end secured by the first crimp channel and the second end secured by the second crimp channel, the flexible loop comprising an external portion and a portion positioned within the channel in the decoy body;
wherein the external portion forms a carrying loop external to the decoy body that extends outwardly between the first opening and the second opening.

2. (canceled)

3. The holding system of claim 1, wherein the metal crimp is securely positioned within the channel in the decoy body.

4-6. (canceled)

7. The holding system of claim 1, wherein the flexible loop member is a bungee cord.

8. The holding system of claim 1, wherein the channel comprises two non-coaxial portions.

9-16. (canceled)

17-20. (canceled)

21. The holding system of claim 8, wherein one non-coaxial portion of the channel comprises a first non-coaxial channel portion and wherein the other non-coaxial portion of the channel comprises a second non-coaxial channel portion, the first non-coaxial channel portion having a smaller diameter than the second non-coaxial channel portion.

22. The holding system of claim 21, wherein the metal crimp is lodged in the second non-coaxial channel portion.

23. The holding system of claim 22, wherein the flexible loop member extends through the first non-coaxial channel portion and into the metal crimp such that the first end of the flexible loop member is secured within the second non-coaxial channel portion.

24. The holding system of claim 23, wherein the flexible loop member also extends into the second non-coaxial channel portion and into the metal crimp such that the second end of the flexible loop member is secured within the second non-coaxial channel portion.

25. A holding system for a decoy having a decoy body, comprising:
a channel in the decoy body comprising a first opening and a second opening in the decoy body, the channel defining a continuous, enclosed path between the first opening and the second opening;
wherein the channel comprises two non-coaxial portions; and
wherein one non-coaxial portion of the channel comprises a first non-coaxial channel portion and also comprises the first opening in the decoy body, and wherein the other non-coaxial portion of the channel comprises a second non-coaxial channel portion and also comprises the second opening in the decoy body, the first non-coaxial channel portion having a smaller diameter than the second non-coaxial channel portion;
a metal crimp comprising a first crimp channel and a second crimp channel, wherein the metal crimp is lodged in the second non-coaxial channel portion; and
a flexible loop member comprising a bungee cord and having a first end and a second end fixedly secured by the metal crimp, each end of the flexible loop member being positioned at opposite ends of the metal crimp, the first end of the flexible loop member secured by the first crimp channel and the second end of the flexible loop member secured by the second crimp channel, the flexible loop member comprising an external portion and a portion positioned within the channel in the decoy body;
wherein the flexible loop member extends through the first non-coaxial channel portion and into the metal crimp such that the first end of the flexible loop member is secured by the metal crimp within the second non-coaxial channel portion; and
wherein the flexible loop member also extends into the second non-coaxial channel portion and into the metal crimp such that the second end of the flexible loop member is secured within the second non-coaxial channel portion, such that the external portion of the flexible loop member forms a seamless, continuous carrying loop external to the decoy body that extends outwardly between the first opening and the second opening.
